(19) United States
(12) Patent Application Publication
(10) Pub. No.: US 2023/0042827 A1
(43) Pub. Date: Feb. 9, 2023

(54) FOG INJECTION NOZZLE

(71) Applicant: COUNTERFOG EBT DE LA UAH SL, Madrid (ES)

(72) Inventors: José Luis PÉREZ DÍAZ, Madrid (ES); Juan SÁNCHEZ GARCÍA-CASARRUBIOS, Madrid (US)

(21) Appl. No.: 17/972,951

(22) Filed: Oct. 25, 2022

Related U.S. Application Data
(63) Continuation of application No. PCT/ES2021/070232, filed on Apr. 8, 2021.

(30) Foreign Application Priority Data
Apr. 25, 2020 (ES) P202030349

(51) Int. Cl. B05B 1/34

(52) U.S. Cl. CPC B05B 1/3447

(57) ABSTRACT

A fog injection nozzle able to generate a swirling cone of fog. The nozzle includes an internal cavity into which a pressurized liquid and a pressurized gas are introduced. The pressurized liquid is introduced into the cavity via a central axial duct of a cylindrical block and the pressurized gas is introduced into the cavity via a plurality of axial through holes disposed about the central axial duct. The axial through holes and radial arms are arranged such that a mixture of the liquid and gas inside the cavity is asymmetrically deflected by the radial arms to cause a swirling tangential component to appear in the conical flow of fog discharged from the nozzle.

### CROSS-REFERENCE TO RELATED APPLICATIONS

This application is a continuation of International Application PCT/ES2021/070232, filed on Apr. 8, 2021, which claim priority to Spanish Application No. P202030349, filed Apr. 25, 2020. The entirety International Application PCT/ES2021/070232 is incorporated in its entirety into the present continuation application by reference.

### FIELD OF THE INVENTION

The present invention belongs to the field of injection of a fog capable of decontaminating air and solid surfaces of objects, and is particularly related to a new, simpler nozzle which injects a cone-shaped rotating fog volume.

### BACKGROUND

Currently, the use of spray nozzles capable of spraying one or more liquids in the form of small-sized particles for various applications such as firefighting, decontamination tasks, cleaning industrial waste, etc., among others, is well-known. In particular, the decontamination of public facilities and critical infrastructures has recently gained a great importance due to worldwide situation created by the Covid-19 pandemic.

Up to very recently, nozzles used were only useful for surface decontamination, as the size of the particles generated was too large to produce a relevant decontamination in terms of airborne contaminant particles. Moreover, the very small size of certain pollutant particles means that, even when they are “laying on” a surface, any weak air flow can raise them up into the air. This is the case, for example, for viruses such as Covid-19. So, when using conventional cleaning nozzles that emit large liquid particles, the flow created around each particle when it hits the surface could cause viruses around its point of impact onto the surface to be re-suspended up into the air, subsequently falling back down onto the same or other surfaces nearby. In short, it is clear that conventional decontamination nozzles are not efficient.

The inventors of the present application have recently discovered that the generation of a fog with a droplet size distribution with a large submicrometric fraction, for example between 0.1 μm and 20 μm, which is also injected under pressure, therefore tending to form a conical fog jet with a large axial velocity gradient, and which also has a tangential component, leads to the appearance of a Venturi effect which causes airborne pollutant particles in the air to be absorbed by the fog. The inventors of the present application describe this cleaning procedure in detail in document EP3406317A1. Furthermore, the small size of the particles emitted by this nozzle avoids the appearance of strong flows when they fall on a surface, thus avoiding the re-suspension in the air of very small contaminant particles such as viruses and so on. Furthermore, the inventors of the present application describe in document EP3395449A1 a new fog cone generation nozzle capable of carrying out the procedure described in the previous paragraph.

In effect, this new nozzle generates a spiral cone of fog made up of submicron-sized particles that can be used for the purpose of simultaneously decontaminating air and surfaces. As can be seen in FIG. 1, which corresponds to the second figure of document EP3395449A1, the described nozzle (100) is formed by a plurality of parts arranged along an axial direction and firmly fixed to each other through two casing portions (110, 120) arranged respectively in the upper and lower part of said figure. Liquid enters through an axial inlet port (130), while air enters through a radial inlet port (140). The parts responsible for fog generation in this nozzle (100) are mainly a spiral module (150) and a nozzle pin (160) located in front of an outlet port of the spiral module (150). The spiral module (150) has an essentially cylindrical shape comprising a central hole (152) through which the liquid introduced through the inlet port (130) passes and some tangential channels (151) through which passes the air introduced through the port (140). The tangential channels (151) cause the appearance of a radial component in the air flow before it mixes with the liquid. After passing the spiral module (150), the air and the liquid are mixed and said liquid/air mixture arrives, with a velocity that preserves the radial component, at the nozzle pin (160). The liquid/air mixture then passes through holes (161) arranged between radial elements (162) that connect an axial stem (163) of the nozzle pin (161) with a transverse disc (164), and finally it exits through the outlet hole (170) of the nozzle (100). This generates a swirling conical fog jet provided with sub-micrometric droplets at the outlet, which is capable of cleaning both air and surfaces.

As it can be seen, the configuration of the nozzle described in document EP3395449A1 is quite complex and is composed of a large number of parts. Moreover, the intricately shaped parts, such as the spiral module, require the use of excessively long and complicated manufacturing processes.

In short, there is currently a need in the technical field for nozzles capable of emitting a rotating cone-shaped fog, whose configuration is simpler and whose component parts require less manufacturing effort.

### SUMMARY OF THE INVENTION

The nozzle of the present invention solves the above problems thanks to a novel design that reduces the number of parts and their complexity, while maintaining the ability to generate a rotating conical flow of fog at the outlet. In addition, the new design described in this document makes it possible to select, during assembly, the magnitude of the rotational effect of the conical fog jet generated.

In this document, the “axial axis” refers to the main central axis of the nozzle, the overall shape of which may be cylindrical.

In this document, the term “forward” refers to the main direction of liquid flow along the axial axis from an inlet end of the nozzle to an outlet end of the nozzle. That is, the outlet end of the nozzle is located at a front side thereof, while the inlet end of the nozzle is located at a rear side of the nozzle.

In this document, the term “transverse” refers to a plane perpendicular to the axial axis of the nozzle of the invention. In turn, the “cross section” of a specific element, unless otherwise indicated, refers to a section perpendicular to a main axis of said element. For example, in the case of the radial arms, their cross section is perpendicular to the main direction along which said radial arms extend.

The present invention describes an improved fog injection nozzle for emitting a rotating conical flow of fog formed by liquid particles suspended in a gas. This nozzle comprises a body provided with a first axial cylindrical cavity traversed by an axial liquid conduit connected at its rear end to a pressurized liquid inlet port. A pressurized gas inlet port is also connected to said first cavity by means of a radial conduit. The nozzle further comprises a cylindrical block that covers a front side of the first cavity and that is provided with a central axial conduit connected to the front end of the axial liquid conduit. The body comprises a second axial cylindrical cavity for mixing liquid and gas arranged on the front side of the cylindrical block. The nozzle further comprises an outlet pin located in an axial outlet passage of the nozzle which is attached to a front side of the second cavity. A front end of the outlet pin comprises an axial stem provided with a flare located at the front end of said axial nozzle outlet duct, such that the flare guides the flow of liquid and gas to generate a conical flow of fog. In turn, a rear end of the output pin comprises a hollow transverse disc which disc is connected to the rear end of the axial stem by means of equally spaced angular radial arms.

The nozzle structure described up to this point is known from EP3395449. However, the nozzle of the present invention differs from that in the way that a rotating component is achieved to be imparted to the emitted conical flow. In the nozzle of document EP3395449, pressurized air was introduced into the second cavity through tangential channels in the cylindrical block. The present invention achieves a similar effect by replacing these difficult-to-manufacture tangential channels with much more easily manufactured axial channels.

In fact, in the nozzle of the present invention, the cylindrical block comprises axial holes that join the first cavity with the second cavity for the passage of pressurized gas. These axial holes are radially spaced from the central axis of the cylindrical block and angularly equally spaced. Also, the number of axial holes of the cylindrical block is the same as the number of radial arms of the output pin. Thus, the cylindrical block and the output pin are configured in such a way that the mixture of liquid and gas driven by the pressurized gas injected through the axial holes of the cylindrical block is deflected asymmetrically by the respective radial arms, causing the appearance of a rotating tangential component in the conical flow of fog emitted by the nozzle.

In this way, it is possible to generate a tangential component in the conical flow of fog emitted without the need for moving parts or parts with intricate shapes that are difficult to manufacture. In principle, this effect can be achieved in different ways, although two particularly preferred embodiments are described in this document. In a first preferred embodiment, the tangential effect on the outflow is achieved by a misalignment between the axial holes of the cylindrical block and the radial arms. In a second preferred embodiment, alternative to the first preferred embodiment, the tangential effect is achieved by means of a suitable shape of the portion of the arms where the flow discharging from the second cavity impacts on. Each of these preferred embodiments is described in more detail below.

According to a first embodiment of the nozzle, the cylindrical block and the output pin are angularly misaligned relative to the position of said axial holes and said radial arms. In other words, the flow of pressurized gas injected through the axial holes of the cylindrical block, which carries liquid particles with it, does not hit the center of the respective radial arms, but does so in a laterally offset position relative to the main direction of each arm. This means that the flow of gas and liquid particles is not deflected symmetrically on both sides of each arm, but rather that a larger portion of the flow passes through one side of the arm than the other. As a consequence, a tangential component is generated in the direction of the resulting flow downstream of the arms.

This configuration makes it possible to modify the magnitude of the tangential component of the conical outlet flow of the nozzle by means of a suitable selection of the angular misalignment between the cylindrical block and the outlet pin during assembly of the nozzle. This angle can in principle be freely selected, since both elements have an essentially cylindrical shape that can be mounted inside the nozzle body in any orientation. The greater the misalignment, the greater the tangential component of the outflow. More specifically, in preferred embodiments of the invention, the misalignment angle can be between 0° and 60°, preferably between 5° and 45°, and even more preferably between 5° and 13°. In particular, the inventors of the application have found that a particularly advantageous value of the angle of misalignment is approximately 9°.

In principle, the shape of the portion of the arms where the flow of gas and liquid particles impacts can have different shapes, including a flat shape contained in a plane transverse to the main axis of the nozzle. However, preferably the cross section of the portion of the radial arms impacted by the flow of liquid and gas driven by the pressurized gas injected through the axial holes of the cylindrical block comprises a central peak that separates two essentially equal descending curved sections. These two curved sections can have a suitably calculated shape to minimize the speed or pressure losses of the outlet flow and, at the same time, print the desired characteristics to its tangential component.

Thus, when the axial holes and radial arms are aligned, each radial arm divides the flow of liquid and gas into two essentially equal portions. In this case, no component is printed tangential to the conical flow exiting the nozzle, which is therefore not rotating. In contrast, when the axial holes and radial arms are misaligned, each radial arm directs most of the liquid and gas flow to one side of the radial arms. In this case, a component tangential to the conical flow exiting the nozzle is printed in an optimized manner.

According to a second embodiment of the nozzle, the cross section of the portion of the radial arms impacted by the mixture of liquid and gas propelled by the pressurized gas injected through the axial holes of the cylindrical block has a lateral peak which, when the axial holes and radial arms are aligned, directs most of the liquid and gas flow to one side of the radial arms.

That is, the cylindrical block and the output pin in this case are mounted in such a way that axial holes and cylindrical holes are aligned, and the very shape of the portion of the arms on which the air and gas flow impacts causes the appearance of the tangential component. This shape can be suitably selected to obtain tangential components of different magnitudes and characteristics.

Thus, this new nozzle configuration makes it possible to obtain a rotating cone of fog at the outlet in a simpler way than the nozzle of the prior art.

As for the liquid and gas feed pressures, they should preferably be of the same order to achieve the appropriate droplet size distribution, the gas pressure being preferably between 8 and 12 bar and the liquid pressure preferably between 6 and 12 bar.

In principle, this nozzle can be implemented in different ways and using parts of different shapes and in different numbers. For example, in a particularly preferred embodiment of the invention, the body is divided along an axial plane into a first body portion and a second body portion engageable with each other by screwing along respective flat axial faces. In this case, the periphery of a flat axial face of the first body portion may comprise a channel for receiving a seal that leaves two gaps close to the axial duct unsealed. As will be described later in more detail, this configuration is particularly advantageous because it increases the gradient imprinted on the injected fog cone, thus improving its effectiveness.

In short, the nozzle of the described invention provides a tangential component in the output flow using simpler parts and fewer than the nozzle described in document EP3395449.

### BRIEF DESCRIPTION OF THE FIGURES

FIG. 1 shows a longitudinal section of a prior art nozzle described in EP3395449.

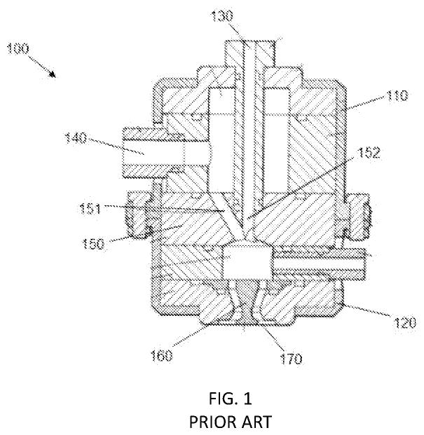

FIG. 2 shows a perspective view of a scroll module of the nozzle of FIG. 1.

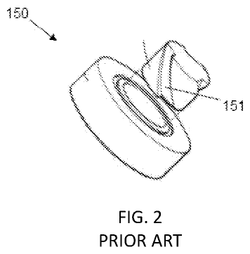

FIG. 3 shows a perspective view of a nozzle pin of the nozzle of FIG. 1.

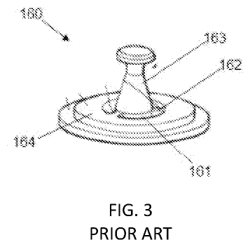

FIG. 4 shows a perspective view of a nozzle according to one embodiment.

FIG. 5 shows another perspective view of the nozzle of FIG. 4.

FIGS. 6A and 6B respectively show first and second body portions of the nozzle of FIG. 4.

FIG. 7 shows a longitudinal sectional view of the nozzle of FIG. 4.

FIG. 8 shows a perspective view of a cylindrical block shown in FIG. 7.

FIG. 9 shows a perspective view of an outlet pin shown in FIG. 7

FIGS. 10A and 10B respectively show an axial view from the outlet end of the nozzle and a section through an axial hole of the cylindrical block when axial holes and radial arms are aligned.

FIGS. 11A and 11B respectively show an axial view from the outlet end of the nozzle and a section through an axial hole of the cylindrical block when axial holes and radial arms are misaligned.

FIGS. 12A-12C show the effect of angular misalignment between axial holes of the cylindrical block and radial arms according to one embodiment.

FIGS. 13A-13B show the effect of the shape of the radial arms when axial holes and radial arms are aligned according to a second embodiment.

### DETAILED DESCRIPTION

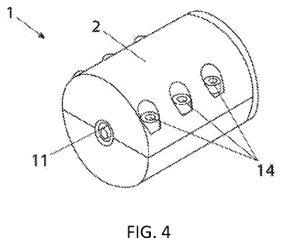

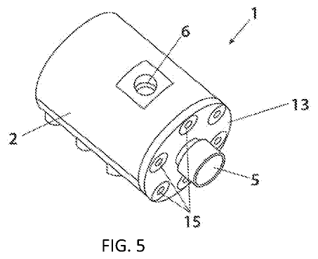

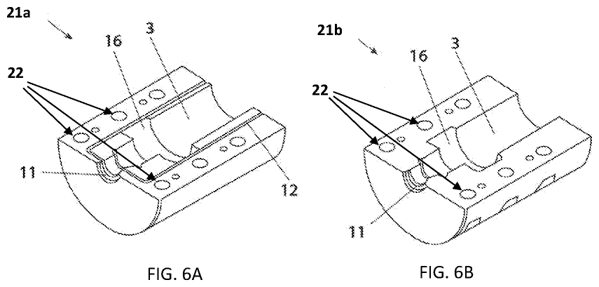

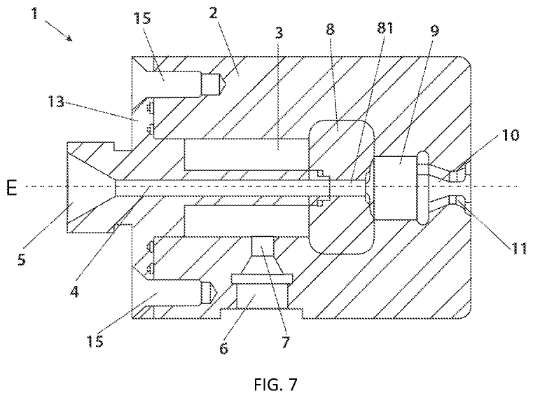

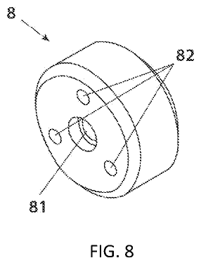

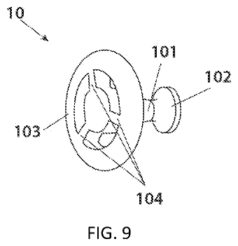

The present invention is herein described with reference to FIGS. 4-13 attached.

The nozzle (1) of the present invention is formed by a body (2) which is formed by two halves (21a, 21b) separated along a flat axial face. The two halves (21a, 21b) have two rows of three holes (22) arranged along the side walls of their respective flat axial face for fixing by means of screws (14). An additional piece (13) in the form of a transverse disc is fixed, also by means of screws (15), to the rear end of the body (2) of the nozzle (1). Furthermore, the peripheral walls of the flat axial face of the first half (21) are traversed by a channel (12) for receiving a seal (not shown). An adequate selection of the tightening force of the screws (14) causes that, during the use of the nozzle (1), a small part of air escapes through the slot closed by the sealing gasket. This small air leak causes an enhancing effect on the rotational properties of the emitted fog, as will be described in greater detail later in this document.

The transverse disc (13) that closes the rear end of the body (2) comprises, on its front face, an axial conduit (4) for liquid that runs through a first cylindrical cavity (3) of the nozzle (1) whose diameter is substantially greater than that of said axial duct (4). At its rear end, the axial liquid conduit (4) is connected to a pressurized liquid inlet port (5). The liquid inlet port (5) is formed on a rear side of the transverse disc (13) itself. At its front end, this axial liquid conduit (4) is joined to an axial conduit (81) of a cylindrical block (8) located inside a housing (16) adjacent to the front end of the first cavity (3). The gas inlet to the nozzle (1) takes place in a radial direction through a gas inlet port (6) connected to the first cavity (3) through a radial duct (7).

Therefore, the liquid introduced through the inlet port (5) runs through the axial conduit (4), passes through the axial conduit (81) of the cylindrical block (8) that covers the front side of the first cavity (3), and exits into a second cylindrical cavity (9) through the front end of said axial duct (81). The cylindrical block (8) also has three axial holes (82) radially separated from the central axis (E) and equally spaced angularly. These axial holes (82) join the first cavity (3) with a second cavity (9) located on the front side of the cylindrical block (8). In this way, the pressurized gas that is introduced into the first cavity (3) through the inlet port (6) passes, through said axial holes (82), to the second cavity (9). Therefore, in the second cavity (9) the interaction between the pressurized gas flow and the pressurized liquid flow takes place. In particular, the pressurized liquid flow emitted through the axial conduit (81) impacts against a rear end surface of an output pin (10), which is described later, fragmenting into small size particles. The pressurized gas injected through the axial holes (82) then entrains these particles through an axial outlet duct (11) of the nozzle (1) located on the front side of the second cavity (9).

The axial duct (11) takes the form of a nozzle whose section is decreasing in a first section, and increasing in the second section, thus connecting the second cavity (9) with the outside of the nozzle (1). Inside the axial duct (11) there is an outlet pin (10) that guides the fog flow to generate a rotating conical flow at the outlet of the nozzle. The output pin (10) is basically formed by an axial rod (101) located on its front side and connected to a hollow transverse disc (103) located on its rear side. The axial stem (101) has a first portion that narrows to run through the first section of the nozzle with a decreasing section of the axial duct (11) parallel to its walls. A second portion of the axial stem (101) is formed by a widening (102) that runs through the second section of the nozzle with an increasing section of the axial duct (11) also parallel to its walls. For its part, the hollow transverse disc (103) is connected to the rear end of the axial stem (101) through three radial arms (104) equally spaced angularly. As can be seen, the rear surface of the radial arms (104) has a flat cross-sectional shape. Furthermore, the distance between the axial holes (82) of the cylindrical block (8) and the main axis (E) of the nozzle (1) is selected such that the axial holes (82) are located opposite the area of the arms radials (104) of the hollow transverse disc (103).

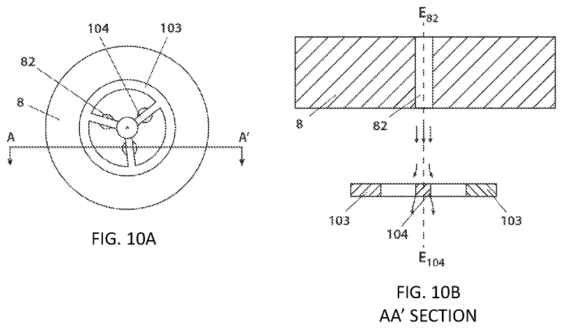

Thus, when the cylindrical block (8) and output pin (10) are angularly aligned, the flow emitted through each axial hole (82) impacts the center of a respective radial arm (104). This situation is shown in greater detail in FIGS. 10A and 10B. Specifically, in the section of FIG. 10B it can be seen how the axis (E82) of the axial hole (82) is completely aligned with the axis (E104) of the radial arm (104) located opposite it. The pressurized air flow injected through the axial hole (82) thus impacts the center of the corresponding radial arm (104), and is divided on each side thereof into two approximately equal portions. In this situation, no radial component is generated in the fog emitted at the outlet of the nozzle (1).

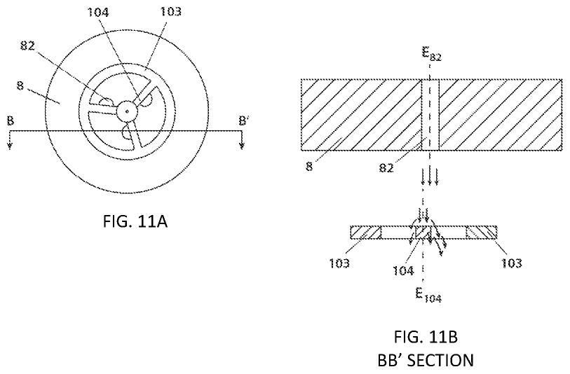

In contrast, FIGS. 11A and 11B show a situation where the cylindrical block (8) is not angularly aligned with the output pin (10). There is a small angular difference between them, so that the axis E82 of each axial hole 82 is offset relative to the axis E104 of the radial arm 104 located opposite it. Naturally, the magnitude of this deviation is less than the diameter of the axial hole (82) itself, so that at least part of the flow of pressurized air injected through each axial hole impacts against the corresponding radial arm (104). In this situation, the symmetry present in the case described in the previous paragraph is lost, the pressurized air flow does not impact against the center of the corresponding radial arm (104), and is therefore divided into two different portions. In this specific case, as shown in FIG. 11B, the portion of flow passing through the left side of the axial arm (104) is substantially larger than the portion of flow passing through the right side of the axial arm (104). This causes the appearance of a tangential component to the left, thus generating the rotating effect in the fog cone emitted by the nozzle (1).

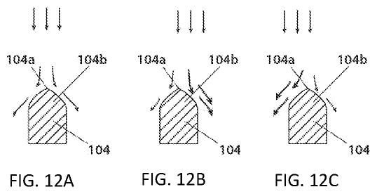

In the previous figures, the rear surfaces of the radial arms (104) have been shown as flat. This causes high losses due to the impact of the flow emitted through the axial holes (82) against said flat surfaces perpendicular to the main direction of the flow. To avoid this, it is possible to provide the rear surfaces of the radial arms 104 with a specially designed shape to reduce losses. For example, as shown in FIGS. 12A-12C, the rear surfaces of the radial arms (104) may be formed by a raised central rib (104a) parallel to the edges of the respective radial arm (104) descending along two lateral valleys (104b).

Thus, as shown in FIG. 12A, when the cylindrical block (8) is aligned with the output pin (10), the flow injected through the axial holes (82) is separated without great losses by the rib (104a) in two essentially equal portions running through the lateral valleys (104b). In this situation, no rotating effect is generated in the fog cone emitted at the outlet of the nozzle (1).

In contrast, FIGS. 12B and 12C show respective situations in which the cylindrical block (8) is not aligned with the output pin (10). In that case, the rib 104a divides the flow injected through the axial holes (82) into two different portions. Specifically, in FIG. 12B the portion of flow descending along the right lateral valley (104b) is much larger than the portion of flow descending along the left lateral valley (104b). Similarly, in FIG. 12C the portion of flow descending along the left lateral valley (104b) is much larger than the portion of flow descending along the right lateral valley (104b). In these cases, the rotating effect is generated in the fog cone emitted at the outlet of the nozzle (1).

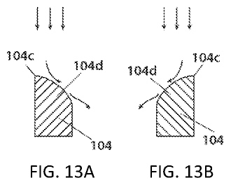

Lastly, FIGS. 13A and 13B show another example of the shape that the rear surfaces of the radial arms (104) can have. In these cases, the raised rib (104c) is not located in the center of the respective arm (104), but is located on one of its sides. Specifically, it is the enlargement of one of the lateral faces of the arm (104), so that the raised rib (104c) is formed by the edge itself. From this rib (104c), the rear surface of the arm descends to the right (FIG. 13A), or to the left (FIG. 13B). This configuration of the radial arms (104) allows the rotational effect to be generated in the fog at the outlet of the nozzle (1) without the need to angularly misalign the cylindrical block (8) and the outlet pin (10). Indeed, with the axial holes (82) aligned with the respective arms (104), the upper surfaces of the radial arms (104) designed in this way direct all of the flow injected through said radial holes (82) well to the right (FIG. 13A) or to the left (FIG. 13B). This configuration has the additional advantage that it allows the magnitude of the rotating effect to be maximized, since it allows all the entire injected flow to be diverted on one or the other side of the radial arm. (104).

In addition, as mentioned previously in this document, in any of the described configurations it is possible to increase the gradient effect printed on the fog cone at the nozzle (1) outlet thanks to a suitable selection of the sealing gasket and the tightening force of the screws (14) that join the two halves (21a, 21b) of the body (2) of the nozzle (1). Indeed, when the continuity of the sealing joint is interrupted near the outlet duct (11), two gaps are produced between the two parts of the assembly through which the fog can escape at high speed. As it occurs only at two angles, it increases the angular asymmetry and therefore the velocity gradients in the fluid-fog-that escapes, which makes it easier to attract surrounding air and trap suspended particles.

What is claimed is:

1. A fog injection nozzle comprising:
a body provided with a first axial cavity and a second axial cavity, the second axial cavity located forward of the first axial cavity;
a first duct that traverses the first axial cavity and is configured to carry a liquid in a forward direction;
a second duct configured to carry a gas into the first cavity;
a block located in a forward end of the first axial cavity and provided with a central axial duct fluidly connected to a front end of the first duct. the block having a central axis and further including at least first and second axial holes fluidly connecting the first cavity with the second cavity for the passage of the gas, the first and second axial holes being spaced from the central axis and angularly equidistantly-spaced apart from one another;
an axial outlet duct located forward of the second axial cavity and configured to receive a mixture of the liquid and the gas; and
an outlet pin located in the axial outlet duct, a front end of the outlet pin including an axial stem provided with a widening located at or near a front end of the axial outlet duct, a rear end of the outlet pin including a transverse disc that is connected to a rear end of the axial stem by at least first and second radial arms that are angularly equidistantly-spaced apart from one another, the first and second radial arms being respectively arranged forward of the first, and second axial holes of the block, a shape of each of the first and second radial arms in conjunction with their arrangement with respect to the first and second axial holes results in the mixture of the liquid and gas located in the second axial chamber to be asymmetrically diverted to first and second lateral sides of each of the first and second radial arms or to be diverted to only one lateral side of the first and second radial arms to produce a rotating conical flow of fog at a nozzle outlet upon the liquid and gas being introduced into the body.

2. The fog injection nozzle according to claim 1, wherein a central axis of each of the first and second axial holes is respectively misaligned with an axis of each of the first and second radial arms so that the mixture of the liquid and gas located in the second axial chamber is asymmetrically diverted to the first and second lateral sides of each of the first and second radial arms.

3. The fog injection nozzle according to claim 1, wherein a section of each of the first and second radial arms upon which the mixture of the liquid and gas impinges includes a central spike.

4. The fog injection nozzle according to claim 3, wherein the central spike has a convex shape.

5. The fog injection nozzle according to claim 1, wherein a section of each of the first and second radial arms upon which the mixture of the liquid and gas impinges comprises the first and second lateral sides, the first lateral side being curved, the second lateral side being flat.

6. The fog injection nozzle according to claim 5, wherein a central axis of each of the first and second axial holes is respectively aligned with an axis of each of the first and second radial arms.

7. The fog injection nozzle according to claim 1, wherein each of the cylindrical block and second axial cavity has a cylindrical shape.

8. The fog injection nozzle according to claim 1, wherein the body is divided along an axial plane into a first body portion and a second body portion.

9. The fog injection nozzle according to claim 8, wherein the first and second body portions respectively comprise first and second flat axial faces and are joined by a plurality of screws that extend across the first and second flat axial faces.

10. The fog injection nozzle according to claim 8, wherein the first and second body portions respectively comprise first and second flat axial faces, at least one of the first and second axial faces including a channel in which resides a sealing gasket, the sealing gasket and channel being configured such that when the first and second body portions are joined, two gaps are produced between the first and second body portions near the axial outlet duct to permit the mixture of the liquid and gas to escape the body at high speed.

11. The fog injection nozzle according to claim 1, wherein the first and second axial holes of the block are each straight and arranged parallel to one another.

12. The fog injection nozzle according to claim 1, wherein the first and second axial holes and the central axial duct of the block are each straight and arranged parallel to one another.

13. The fog injection nozzle according to claim 1, wherein the block includes a third axial hole and the output pin includes a third radial arm, the third axial hole and third radial arm configured to function together to cause a portion of the mixture of the liquid and gas located in the second axial chamber to be asymmetrically diverted to first and second lateral sides of the third radial arm or to be diverted to only one lateral side of the third radial arm.

14. The fog injection nozzle according to claim 2, wherein a section of each of the first and second radial arms upon which the mixture of the liquid and gas impinges includes a central spike.

15. The fog injection nozzle according to claim 2, wherein each of the cylindrical block and second axial cavity has a cylindrical shape.

16. The fog injection nozzle according to claim 2, wherein the body is divided along an axial plane into a first body portion and a second body portion.

17. The fog injection nozzle according to claim 16, wherein the first and second body portions respectively comprise first and second flat axial faces and are joined by a plurality of screws that extend across the first and second flat axial faces.

18. The fog injection nozzle according to claim 16, wherein the first and second body portions respectively comprise first and second flat axial faces, at least one of the first and second axial faces including a channel in which resides a sealing gasket, the sealing gasket and channel being configured such that when the first and second body portions are joined, two gaps are produced between the first and second body portions near the axial outlet duct to permit the mixture of the liquid and gas to escape the body at high speed.

19. The fog injection nozzle according to claim 2, wherein the first and second axial holes of the block are each straight and arranged parallel to one another.

20. The fog injection nozzle according to claim 1, wherein the first and second axial holes and the central axial duct of the block are each straight and arranged parallel to one another.
